(19) United States
(12) Patent Application Publication
(10) Pub. No.: US 2025/0242736 A1
(43) Pub. Date: Jul. 31, 2025

(54) FOOT MASSAGE DEVICE FOR VEHICLE

(71) Applicant: HYUNDAI TRANSYS INC., Seosan-si (KR)

(72) Inventors: Gu Chang KANG, Hwaseong-si (KR); Beom Sun KIM, Hwaseong-si (KR); Ui Jeong LEE, Hwaseong-si (KR)

(21) Appl. No.: 19/032,112

(22) Filed: Jan. 19, 2025

(30) Foreign Application Priority Data
Jan. 29, 2024 (KR) 10-2024-0012907

(51) Int. Cl. B60N 2/90; A61H 39/04

(52) U.S. Cl. CPC B60N 2/976; A61H 39/04; A61H 2201/0149; A61H 2201/149; A61H 2203/0437; A61H 2205/12

(57) ABSTRACT

Disclosed is a foot massage device for vehicles. The foot massage device includes a mounting plate mounted in a seatback of a vehicle, a massage module configured to apply pressure through a plurality of guide holes formed in the mounting plate by selectively drawing out a plurality of acupressure members though the plurality of guide holes such that the plurality of acupressure members protrude alternately and repeatedly, and a moving module coupled to the mounting plate and configured to selectively move the plurality of acupressure members in a forward-backward direction.

### CROSS-REFERENCE TO RELATED APPLICATION

This application claims under 35 U.S.C. § 119 (a) the benefit of priority to Korean Patent Application No. 10-2024-0012907 filed on Jan. 29, 2024, the entire contents of which are incorporated herein by reference.

### BACKGROUND

### (a) Technical Field

The present disclosure relates to a foot massage device for vehicles. More particularly, it relates to a foot massage device for vehicles capable of evenly applying acupressure to the entire areas of the soles of a passenger's feet, thereby relieving fatigue of the passenger during travel of the vehicle.

### (b) Background Art

In general, massage is a medical adjuvant therapy that applies various types of mechanical stimulation to a part of a body of a subject, for example, kneads, presses, pulls, taps, or moves a part of the body, thereby assisting in blood circulation of the subject, regulating modulation of the body, and relieving fatigue of the subject.

The demand for massage has been rising steadily. For economic and time reasons, an increase in demand for massage has led to an increase in demand for massage devices or massage instruments for providing an artificial massage function.

That is, with an increase in demand to relieve fatigue or stress by relaxing tightened muscles through massage, various time- and cost-effective massage devices have been released.

For example, there have been developed devices that provide massage to passengers using massage modules embedded in seats of vehicles such as passenger cars.

However, due to the nature of vehicles, massage devices mounted in the vehicles should not interfere with the driver's driving. Therefore, there is need for development of massage devices for vehicles capable of efficiently providing massage while ensuring safety.

The above information disclosed in this Background section is only for enhancement of understanding of the background of the disclosure, and therefore it may contain information that does not form the related art that is already known in this country to a person of ordinary skill in the art.

### SUMMARY OF THE DISCLOSURE

The present disclosure has been made in an effort to solve the above-described problems associated with the related art, and an aspect of the present disclosure is directed to providing a foot massage device for vehicles in which a massage module is moved in a forward-backward direction so as to be selectively exposed from a front seat through operation of a first motor and a plurality of acupressure members provided at the massage module protrudes alternately and repeatedly from the front seat through operation of a second motor, thereby evenly applying acupressure to the entire areas of the soles of a rear-seat passenger's feet and thus effectively relieving fatigue of the passenger during travel of the vehicle.

In one aspect, the present disclosure provides a foot massage device for vehicles including a mounting plate mounted on a seatback of a vehicle, a massage module configured to apply pressure through a plurality of guide holes formed in the mounting plate, by selectively drawing out a plurality of acupressure members through the plurality of through holes such that the plurality of acupressure members protrude alternately and repeatedly, and a moving module coupled to the mounting plate and configured to selectively move the plurality of acupressure members in a forward-backward direction.

In an example embodiment, the moving module may include a plurality of fastening units configured to be fastened to a rear surface of the mounting plate and configured to be rotated in the forward or reverse direction to selectively move the massage module in the forward-backward direction, a connection belt unit interconnecting the plurality of fastening units, and a power transmission unit configured to transmit power for rotation of the plurality of fastening units to the connection belt unit.

In another example embodiment, each of the plurality of fastening units may include a fastening member including threads formed on an outer peripheral surface thereof so as to be fastened to the mounting plate and a gear member extending from the fastening member and formed to be engaged with the connection belt unit.

In still another example embodiment, the massage module may include a cover unit to which the moving module is configured to be coupled, a first gear unit rotatably coupled to the cover unit, a power transmission unit configured to transmit power for rotation of the first gear unit, and a second gear unit disposed at a position corresponding to the plurality of guide holes and configured to be rotated along with rotation of the first gear unit to cause the plurality of acupressure members to protrude alternately.

In yet another example embodiment, the second gear unit may be disposed on each of both sides of the first gear unit coupled to the center of the cover unit and may face a pair of guide holes spaced vertically about one another among the plurality of guide holes on the mounting plate.

In still yet another example embodiment, the second gear unit may include a first driving member configured to engaged with the first gear unit and include a plurality of first protruding guide holes, a plurality of first acupressure members configured to be disposed in the plurality of first protruding guide holes formed, the plurality of first acupressure members configured to extend through the plurality of first protruding guide holes in varying degrees depending on a rotated state of the first driving member, a case member configured to be rotated together with the plurality of first acupressure members, a plurality of second acupressure members located opposite the plurality of first acupressure members with respect to the case member, the plurality of second acupressure members coupled to the case member so as to be rotated together with the case member, and a second driving member including a plurality of second protruding guide holes formed therein so as to allow the plurality of second acupressure members to be disposed therein, the second driving member configured to be rotated together with the plurality of second acupressure members to cause the plurality of second acupressure members to protrude through the plurality of protruding guide holes in varying degrees.

In a further example embodiment, the first driving member may be rotated at the same speed as the case member and the second driving member.

In another further example embodiment, the plurality of first acupressure members may be elastically bendable in an L-shape, and as the first driving member and the case member are rotated together, each of the plurality of first acupressure members may be configured to reciprocate between a fully protruding position when a corresponding one of the plurality of guide holes is located closest to the case member and a fully retreated position when a protruding guide hole is located farthest from the case member.

In still another further example embodiment, the plurality of second acupressure members may be elastically bendable in an L-shape, and as the second driving member and the case member are rotated together, each of the plurality of second acupressure members may be configured to reciprocate between a fully protruding position when a corresponding one of the plurality of protruding guide holes is located closest to the case member and a fully retreated position when the corresponding one of the plurality of protruding guide holes is located farthest from the case member.

In yet another further example embodiment, the repeatedly protruding/retreating speeds of the plurality of first acupressure members and the plurality of second acupressure members may be regulated by controlling the rotational speed of the first gear unit.

Other aspects and example embodiments of the disclosure are discussed infra.

It is understood that the term “vehicle” or “vehicular” or other similar terms as used herein are inclusive of motor vehicles in general such as passenger automobiles including sport utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The above and other features of the disclosure are discussed infra.

### BRIEF DESCRIPTION OF THE DRAWINGS

The above and other features of the present disclosure will now be described in detail with reference to certain exemplary embodiments thereof illustrated in the accompanying drawings which are given hereinbelow by way of illustration only, and thus are not limitative of the present disclosure, and wherein:

FIG. 1 is a view showing a seatback in which a foot massage device for vehicles according to an embodiment of the present disclosure is mounted;

FIG. 2 is a view showing a massage module and a moving module of the foot massage device for vehicles according to the embodiment of the present disclosure;

FIG. 3 is a view showing a fastening unit of the moving module of the foot massage device for vehicles according to the embodiment of the present disclosure;

FIG. 4 is a view showing the structures of a first gear unit and a second gear unit of the foot massage device for vehicles according to the embodiment of the present disclosure;

FIG. 5 is a view showing the operational states of the first gear unit and the second gear unit of the foot massage device for vehicles according to the embodiment of the present disclosure; and

FIG. 6 is a view showing the second gear unit of the foot massage device for vehicles according to the embodiment of the present disclosure.

It should be understood that the appended drawings are not necessarily to scale, presenting a somewhat simplified representation of various example features illustrative of the basic principles of the disclosure. The specific design features of the present disclosure as disclosed herein, including, for example, specific dimensions, orientations, locations, and shapes, will be determined in part by the particular intended application and use environment.

In the figures, reference numbers refer to the same or equivalent parts of the present disclosure throughout the several figures of the drawing.

### DETAILED DESCRIPTION

Hereinafter, reference will now be made in detail to various embodiments of the present disclosure, examples of which are illustrated in the accompanying drawings and described below.

Advantages and features of the present disclosure and methods for achieving the same will be made clear from embodiments described below in detail with reference to the accompanying drawings.

The present disclosure may, however, be embodied in many different forms, and should not be construed as being limited to the embodiments set forth herein. Rather, these embodiments are provided so that this disclosure will be thorough and complete, and will fully convey the scope of the disclosure to those skilled in the art. The present disclosure is defined only by the scope of the claims.

In the following description of the embodiments disclosed in the present specification, a detailed description of known functions and configurations incorporated herein will be omitted when the same may make the subject matter of the embodiments disclosed in the present specification rather unclear.

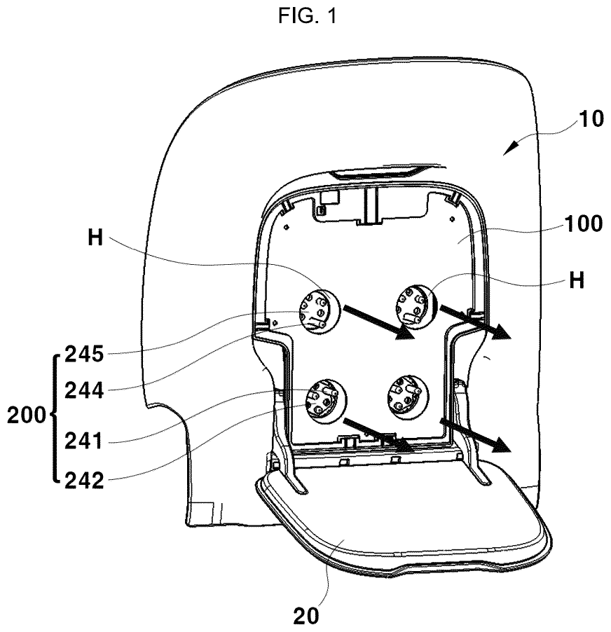

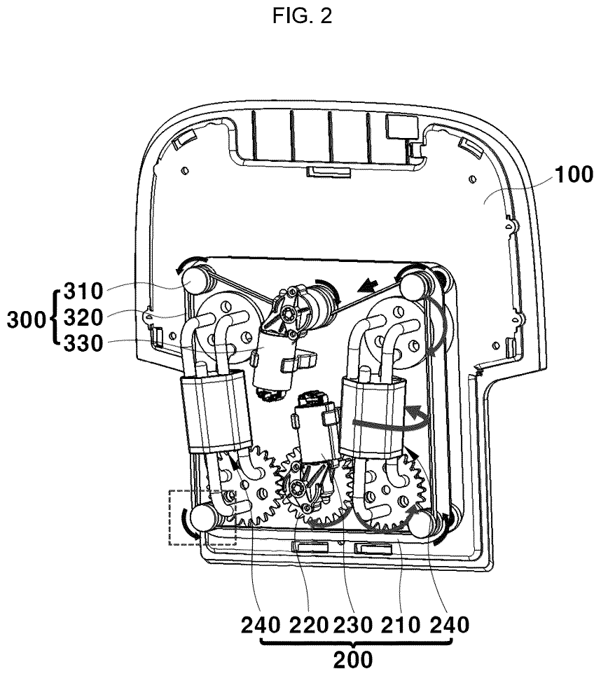

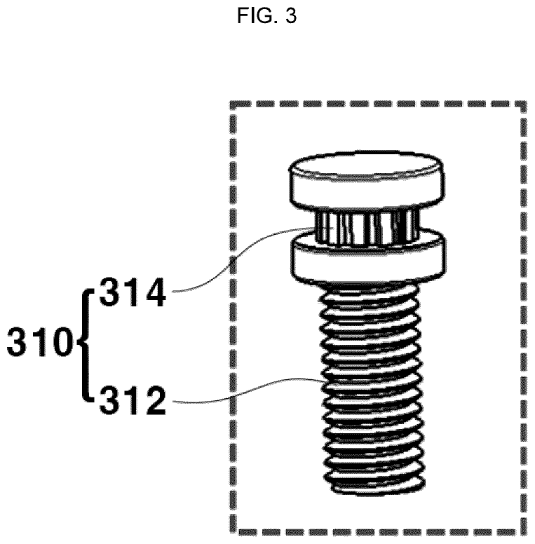

FIG. 1 is a view showing a seatback in which a foot massage device for vehicles according to an embodiment of the present disclosure is mounted. FIG. 2 is a view showing a massage module and a moving module of the foot massage device for vehicles according to the embodiment of the present disclosure. FIG. 3 is a view showing a fastening unit of the moving module of the foot massage device for vehicles according to the embodiment of the present disclosure.

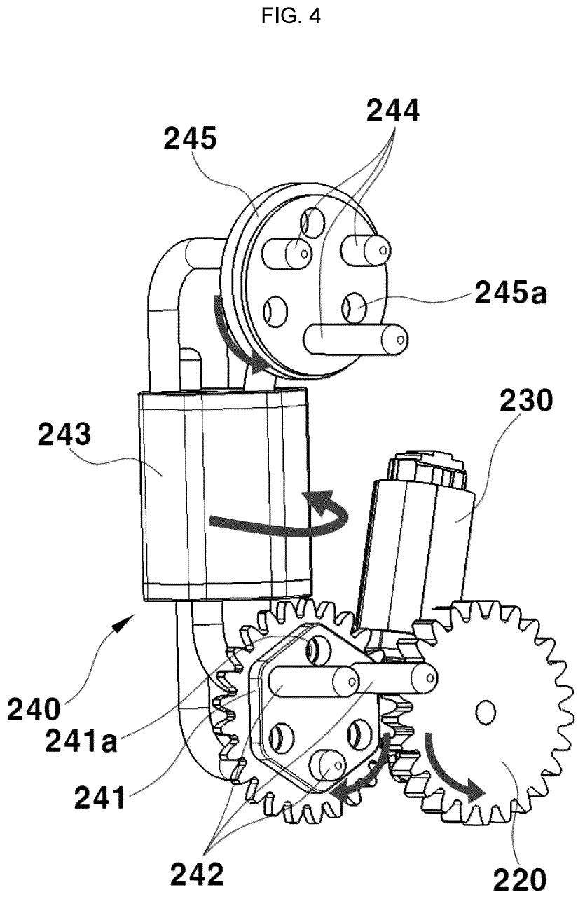

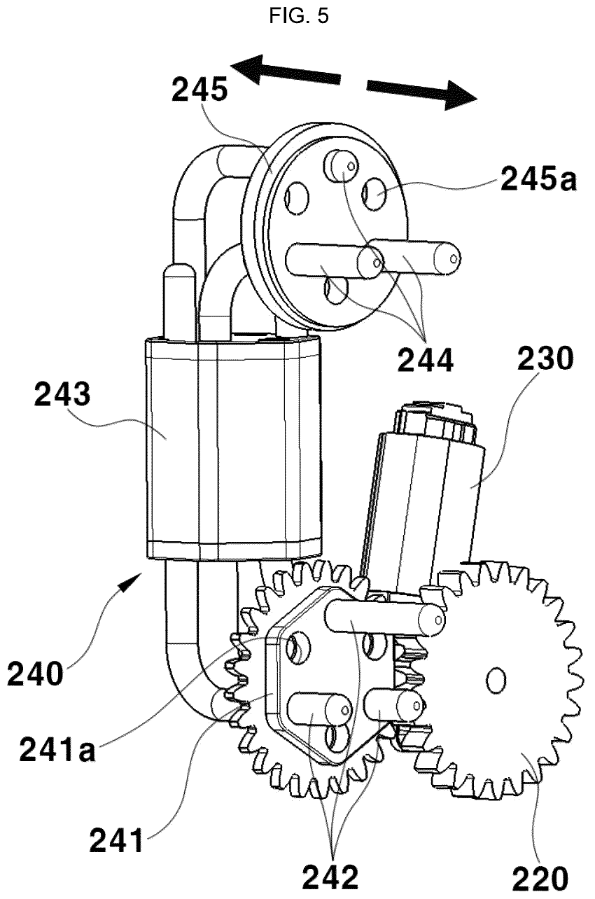

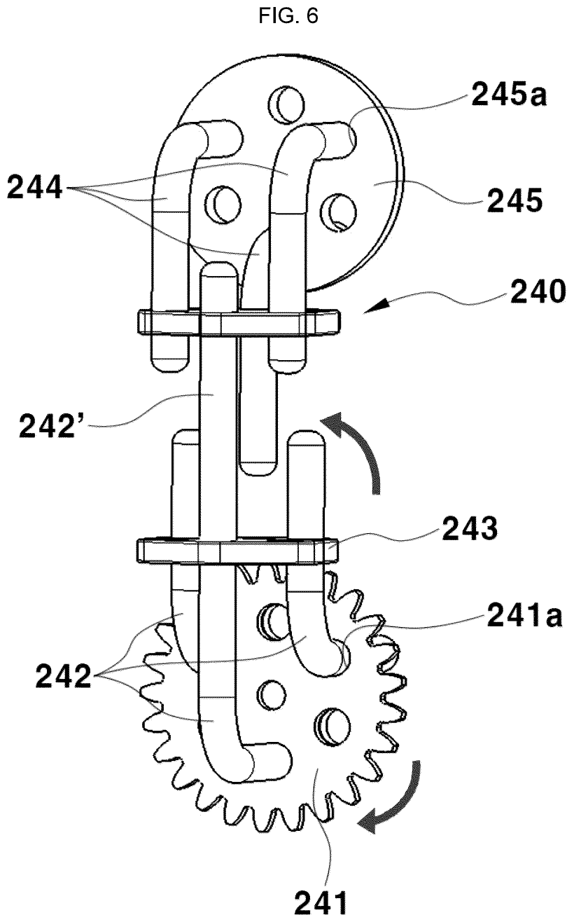

FIG. 4 is a view showing the structures of a first gear unit and a second gear unit of the foot massage device for vehicles according to the embodiment of the present disclosure. FIG. 5 is a view showing the operational states of the first gear unit and the second gear unit of the foot massage device for vehicles according to the embodiment of the present disclosure. FIG. 6 is a view showing the second gear unit of the foot massage device for vehicles according to the embodiment of the present disclosure.

When a passenger stays in the vehicle for a long time, he or she may be easily fatigued. Therefore, the passenger may require an appropriate intensity of massage for assistance in blood circulation in order to effectively relieve tension.

Conventionally, a massage device using an air pocket is mounted in a seat or a footrest of a vehicle in order to massage a passenger. However, such a massage device using an air pocket provides a relatively low intensity of massage. Thus, it is difficult for a passenger to obtain his/her desired intensity of massage.

According to the embodiment, there is provided a foot massage device for vehicles configured to provide foot massage to a rear-seat passenger. The foot massage device for vehicles according to the embodiment performs massage using acupressure on the entire areas of the soles of the rear-seat passenger's feet in the state in which the passenger stretches his or her both legs, thereby enabling the rear-seat passenger to effectively relieve fatigue of the soles of his or her feet during travel of the vehicle.

To this end, the foot massage device for vehicles according to the embodiment includes a mounting plate 100, a massage module 200, and a moving module 300.

As shown in FIG. 1, the mounting plate 100 is mounted in a seatback 10. More preferably, the mounting plate 100 is mounted at a position at which the mounting plate 100 faces the soles of the rear-seat passenger's feet when the rear-seat passenger's legs are supported by a seatback cover 20 deployed to a predetermined angle.

The mounting plate 100 includes two left-upper and left-lower guide holes H and two right-upper and right-lower guide holes H formed therein so as to face the soles of the rear-seat passenger's left and right feet, respectively.

The massage module 200 may apply pressure through the guide holes H and by selectively drawing out a plurality of acupressure members 242 and 244 through the guide holes H such that the plurality of acupressure members 242 and 244 protrude alternately and repeatedly.

To this end, as shown in FIG. 2, the massage module 200 may include a cover unit 210, a first gear unit 220, a power transmission unit 230, and a second gear unit 240. In this case, the second gear unit 240 is provided in a pair, and the pair of second gear units 240 is disposed at positions facing the left and right guide holes H, respectively.

The moving module 300 is coupled to the mounting plate 100 and, in response to operation by the passenger, selectively moves the massage module 200 in a forward-backward direction so that the plurality of acupressure members 242 and 244 of the massage module 200 protrude from the mounting plate 100 through the guide holes H or are retreated from the guide holes H.

The moving module 300 includes a fastening unit 310, a connection belt unit 320, and a power transmission unit 330.

Here, the fastening unit 310 is provided in plural, and the plurality of fastening units 310 is fastened to a rear surface of the mounting plate 100, and is rotated in the forward or reverse direction to selectively move the massage module 200 in the forward-backward direction.

In other words, as shown in FIG. 2, the fastening units 310 are fastened to respective corners of the cover unit 210 on the rear surface of the mounting plate 100, and are rotated in a fastening or releasing direction to move the massage module 200 in the forward-backward direction.

As shown in FIG. 3, each of the fastening units 310 includes a fastening member 312 and a gear member 314.

The fastening member 312 has threads formed on the outer peripheral surface thereof so as to be fastened to the mounting plate 100. Through this structure, when rotated in the forward or reverse direction, the fastening member 312 may be fastened to or released from the rear surface of the mounting plate 100 together with the cover unit 210.

For example, when rotated in the forward direction on the mounting plate 100 in response to operation by the passenger, the fastening member 312 may move the cover unit 210 in a direction to bring the cover unit 210 into contact with the rear surface of the mounting plate 100. Accordingly, a plurality of first acupressure members 242 and a plurality of second acupressure members 244 provided at the massage module 200 may alternately protrude through the plurality of guide holes H.

The gear member 314 extends from the fastening member 312 and is engaged with the inner surface of the connection belt unit 320. Accordingly, the gear member 314 rotates the fastening member 312 in the forward or reverse direction along with operation of the connection belt unit 320.

The connection belt unit 320 is formed to interconnect the gear members 314 fastened to the respective corners of the cover unit 210 on the rear surface of the mounting plate 100.

The power transmission unit 330 is implemented as a motor. The power transmission unit 330 transmits power for rotation of the fastening unit 310 to the connection belt unit 320, thereby causing the fastening unit 310 to rotate in the forward or reverse direction in order to move the massage module 200 in the forward-backward direction.

Accordingly, when the rear-seat passenger wants to receive massage on the soles of his or her feet, the power transmission unit 330 selectively drives the connection belt unit 320 so that the first acupressure members 242 and the second acupressure members 244 of the massage module 200 protrude through the plurality of guide holes H.

As shown in FIG. 2, the massage module 200 includes the cover unit 210, the first gear unit 220, the power transmission unit 230, and the second gear unit 240 described above.

The above-described moving module 300, specifically, the fastening unit 310, is disposed so as to penetrate each of the corners of the cover unit 210, and the power transmission unit 330 is disposed at the center of the upper portion of the cover unit 210.

The first gear unit 220 is rotatably coupled to the cover unit 210.

In more detail, the first gear part 220 is disposed at the center of the lower portion of the cover unit 210 considering the layout, etc., and is rotated by the power transmission unit 230.

In addition, the power transmission unit 230 is disposed so as to be spaced apart from the power transmission unit 330 of the moving module 300, and transmits power for rotation of the first gear unit 220.

As shown in FIG. 2, the second gear unit 240 is provided in a pair, and the pair of second gear units 240 is located corresponding to the left guide holes H spaced vertically about one another and the right guide holes H spaced vertically about one another, respectively. The pair of second gear units 240 is rotated along with rotation of the first gear unit 220, thereby causing the plurality of acupressure members 242 and 244 to protrude alternately.

More preferably, the second gear units 240 are disposed on both sides of the first gear unit 220 so that each of the second gear units 240 faces a corresponding pair of guide holes H spaced vertically about one another. Accordingly, the second gear units 240 cause the plurality of acupressure members 242 and 244 to selectively protrude through the guide holes H, thereby providing acupressure to the entire areas of the soles of the rear-seat passenger's feet and thus achieving effective massage.

To this end, as shown in FIG. 4, the second gear unit 240 may include a first driving member 241, a first acupressure member 242, a case member 243, a second acupressure member 244, and a second driving member 245.

The first driving member 241 is tooth-engaged with the first gear unit 220. When the first gear unit 220 is rotated in, for example, the counterclockwise direction, the first driving member 241 is rotated in the clockwise direction. Further, during operation of the moving module 200 in a forward-moving direction, the first driving member 241 is exposed outside through the guide hole H formed in the lower portion of the mounting plate 100.

The first acupressure member 242 is provided in plural, and the plurality of first acupressure members 242 is disposed in a plurality of protruding guide holes 241a arranged along the peripheral portion of the first driving member 241 and extends to the case member 243. Accordingly, when the first driving member 241 is rotated, the case member 242 is rotated along therewith through the first acupressure members 242.

In this case, as the first driving member 241 is rotated, the first acupressure members 242 may protrude in varying degrees through the corresponding protruding guide holes 241a.

Each of the plurality of first acupressure members 242 is made of an elastically bendable material such that each can be bent in an L-shape, and is rotated along a circular path so that the first driving member 241 and the case member 243, which are spaced apart about one another in the vertical direction, are rotated together. In this case, one end portion and the other end portion of each of the first acupressure members 242 repeatedly reciprocate through the first driving member 241 and the case member 243, respectively. In this way, the first acupressure members 242 protrude or retreat through the first driving member 241.

In more detail, the first driving member 241 and the case member 243 are rotated at the same speed. As shown in FIG. 5, as the first driving member 241 and the case member 243 are rotated together, the first acupressure members 242 repeatedly protrude and retreat from the protruding guide holes 241a. Each of the first acupressure members 242 may reciprocate between a fully protruding position when the corresponding protruding guide hole 241a is located closest to the case member 243, and a fully retreated position when the corresponding protruding guide hole 241a is located farthest from the case member 243.

Although three first acupressure members 242 are illustrated in the drawings, this is merely an example and the disclosure is not limited thereto. The configuration may be modified such that three or more first acupressure members 242 are disposed in the protruding guide holes 241a and repeatedly protrude and retreat through the protruding guide holes 241a.

Through the above-described configuration, the plurality of first acupressure members 242 protrudes or retreats through the guide holes H formed in the lower portion of the mounting plate 100. When the plurality of first acupressure members 242 protrudes, the same applies acupressure to the soles of the rear-seat passenger's feet. As this operation is repeated, local massage effects may be exhibited.

The plurality of second acupressure members 244 is located opposite the plurality of first acupressure members 242 with respect to the case member 243. The plurality of second acupressure members 244 extends and is coupled to the case member 243 so as to be rotated together with the case member 243.

Preferably, as shown in FIG. 6, one first acupressure member 242′ among the plurality of first acupressure members 242 extends and is coupled to the upper portion of the case member 243, thereby serving as a guide to achieve rotation of the first acupressure members 242 and the second acupressure members 244 without causing interference therebetween.

Each of the plurality of second acupressure members 244 is elastically bendable in an L-shape, and is rotated along a circular path as the case member 243 and the second driving member 245, which are spaced apart about one another in the vertical direction, are rotated together. In this case, one end portion and the other end portion of each of the second acupressure members 244 repeatedly reciprocate through the case member 243 and the second driving member 245, respectively. In this way, the second acupressure members 244 protrude or retreat through the second driving member 245.

In more detail, the case member 243 and the second driving member 245 are rotated at the same speed. As shown in FIG. 5, as the case member 243 and the second driving member 245 are rotated together, the second acupressure members 244 repeatedly protrude and retreat. Each of the second acupressure members 244 protrudes through the protruding guide hole 245a located relatively close to the case member 243, and retreats through the protruding guide hole 245a located relatively far from the case member 243.

Although three second acupressure members 244 are illustrated in the drawings, this is merely an example and the disclosure is not limited thereto. Identically to the first acupressure members 242, three or more second acupressure members 244 may be disposed in the protruding guide holes 245a and repeatedly protrude and retreat through the protruding guide holes 245a.

As a result, according to the embodiment, the plurality of first acupressure members 242 and the plurality of second acupressure members 244 repeatedly protrude and retreat through the guide holes H spaced vertically about one another. Further, the protruding/retreating operation of the plurality of first acupressure members 242 and the plurality of second acupressure members 244 through the guide holes H formed in the left portion of the mounting plate 100 and the protruding/retreating operation of the plurality of first acupressure members 242 and the plurality of second acupressure members 244 through the guide holes H formed in the right portion of the mounting plate 100 are performed identically. Accordingly, the first and second acupressure members 242 and 244 may evenly apply acupressure to the entire areas of the soles of the rear-seat passenger's feet, thereby effectively relieving fatigue of the passenger during travel of the vehicle.

Compared to the conventional massage device using an air pocket, the massage device of the embodiment may provide a high intensity of acupressure and thus may achieve effective massage. Further, the protruding/retreating speeds of the first and second acupressure members 242 and 244 may be regulated by controlling the rotational speed of the first gear unit 220 through the power transmission unit 230, and accordingly, the intensity of acupressure may also be easily regulated.

In addition, according to the embodiment, the massage module 200 is moved in the forward-backward direction through one power transmission unit 330, and the soles of the passenger's left and right feet are evenly massaged through another power transmission unit 230. In this way, massage may be efficiently performed with the minimal number of power transmission units 230 and 330, and accordingly, the volume of the foot massage device may be minimized.

As is apparent from the above description, according to the present disclosure, a massage module may be moved in the forward-backward direction so as to be selectively exposed from a front seat through operation of a first motor, and a plurality of acupressure members provided at the massage module may protrude alternately and repeatedly from the front seat through operation of a second motor. Accordingly, it is possible to evenly apply acupressure to the entire areas of the soles of a rear-seat passenger's feet, thereby effectively relieving fatigue of the passenger during travel of the vehicle.

Further, according to the present disclosure, it is possible to repeatedly stimulate local areas of the soles of the passenger's feet, thereby improving blood circulation of the passenger. Furthermore, it is possible to easily regulate the intensity of acupressure by regulating the driving speed of the second motor, thereby improving user satisfaction.

Although the exemplary embodiments of the present disclosure have been described with reference to the accompanying drawings, it will be apparent to those skilled in the art that various changes in form and details may be made without departing from the technical spirit or essential characteristics of the disclosure set forth herein. Therefore, it should be understood that the above-described exemplary embodiments are illustrative in all aspects and do not limit the present disclosure and all or part of the embodiments can be selectively combined so as to be modified into various forms. Therefore, the true scope of protection of the present disclosure should be determined only by the appended claims.

What is claimed is:

1. A foot massage device comprising:
a mounting plate configured to be mounted on a seatback;
a massage module configured to apply pressure through a plurality of guide holes formed in the mounting plate by selectively drawing out a plurality of acupressure members through the plurality of guide holes such that the plurality of acupressure members protrude alternately and repeatedly; and
a moving module coupled to the mounting plate, the moving module configured to selectively move the plurality of acupressure members in a forward-backward direction.

2. The foot massage device of claim 1, wherein the moving module comprises:
a plurality of fastening units configured to be fastened to a rear surface of the mounting plate, the plurality of fastening units configured to be rotated in the forward or reverse direction to selectively move the massage module in the forward-backward direction;
a connection belt unit interconnecting the plurality of fastening units; and
a power transmission unit configured to transmit power for rotation of the plurality of fastening units to the connection belt unit.

3. The foot massage device of claim 2, wherein each of the plurality of fastening units comprises:
a fastening member including threads formed on an outer peripheral surface thereof so as to be fastened to the mounting plate; and
a gear member extending from the fastening member, the gear member being formed to be engaged with the connection belt unit.

4. The foot massage device of claim 1, wherein the massage module comprises:
a cover unit to which the moving module is configured to be coupled;
a first gear unit rotatably coupled to the cover unit;
a power transmission unit configured to transmit power for rotation of the first gear unit; and
a second gear unit disposed at a position corresponding to the plurality of guide holes, the second gear unit configured to be rotated along with rotation of the first gear unit to cause the plurality of acupressure members to protrude alternately.

5. The foot massage device of claim 4, wherein the second gear unit is disposed on each of both sides of the first gear unit coupled to a center of the cover unit and to face a pair of guide holes spaced vertically about one another among the plurality of guide holes on the mounting plate.

6. The foot massage device of claim 4, wherein the second gear unit comprises:
a first driving member configured to be engaged with the first gear unit and including a plurality of first protruding guide holes;
a plurality of first acupressure members configured to be disposed in the plurality of first protruding guide holes formed, the plurality of first acupressure members configured to extend through the plurality of first protruding guide holes in varying degrees depending on a rotation of the first driving member;
a case member configured to be rotated together with the plurality of first acupressure members;
a plurality of second acupressure members located opposite the plurality of first acupressure members with respect to the case member, the plurality of second acupressure members coupled to the case member so as to be rotated together with the case member; and
a second driving member including a plurality of second protruding guide holes formed therein so as to allow the plurality of second acupressure members to be disposed therein, the second driving member configured to be rotated together with the plurality of second acupressure members to cause the plurality of second acupressure members to protrude through the plurality of protruding guide holes in varying degrees.

7. The foot massage device of claim 6, wherein the first driving member is rotated at a same speed as the case member and the second driving member.

8. The foot massage device of claim 6, wherein the plurality of first acupressure members are elastically bendable in an L-shape, and
wherein, as the first driving member and the case member are rotated together, each of the plurality of first acupressure members is configured to reciprocate between a fully protruding position when a corresponding one of the plurality of protruding guide holes is located close to the case member and a fully retreated position when the corresponding one of the plurality of protruding guide holes is located far from the case member.

9. The foot massage device of claim 6, wherein the plurality of second acupressure members are elastically bendable in an L-shape, and
wherein, as the second driving member and the case member are rotated together, each of the plurality of second acupressure members is configured to reciprocate between a fully protruding position when a corresponding one of the plurality of protruding guide holes is located close to the case member and a fully retreated position when the corresponding one of the plurality of protruding guide holes is located far from the case member.

10. The foot massage device of claim 6, wherein repeated protruding/retreating speeds of the plurality of first acupressure members and the plurality of second acupressure members are regulated by controlling a rotational speed of the first gear unit.
